(19) United States
(12) Patent Application Publication
(10) Pub. No.: US 2017/0283744 A1
(43) Pub. Date: Oct. 5, 2017

(54) PEARLY LIQUID DETERGENT COMPOSITION

(71) Applicant: Henkel AG & Co. KGaA, Duesseldorf (DE)

(72) Inventors: Marouane Antir, JT Hilversum (NE); Sabine Schuemann, Neuss (DE); Thorsten Bastigkeit, Wuppertal (DE); Luca Bellomi, Duesseldorf (DE); Petra Woltery, Bergisch Gladbach (DE); Frank Sonnenschein, Haan (DE)

(73) Assignee: Henkel AG & Co. KGaA, Duesseldorf (DE)

(21) Appl. No.: 15/627,071

(22) Filed: Jun. 19, 2017

(30) Foreign Application Priority Data
Dec. 19, 2014 (DE) 102014226712.9

(51) Int. Cl. C11D 3/20; C11D 3/12; C11D 3/34; C11D 1/37; C11D 3/37; C11D 3/22; C11D 3/00; C11D 3/386; C11D 3/50; C11D 3/33

(52) U.S. Cl. CPC C11D 3/2093; C11D 3/505; C11D 3/1266; C11D 3/3409; C11D 3/33; C11D 3/3765; C11D 3/225; C11D 3/0089; C11D 3/38645; C11D 3/38618; C11D 3/38636; C11D 1/37; C11D 1/29

(57) ABSTRACT

The present invention relates to a pearly liquid detergent composition comprising a thickener, a pearlescent agent and perfume capsules. The present invention further relates to a method for cleaning textiles using such a pearly liquid detergent composition.

### FIELD OF THE INVENTION

The present invention generally relates to a pearly liquid detergent composition comprising a thickener, a pearlescent formulation, and perfume capsules. The present invention further relates to the use of such liquid detergent compositions for the cleaning of laundry and a process for cleaning laundry using such liquid detergent composition. The present invention also describes a method for manufacturing such a pearly liquid detergent composition.

### BACKGROUND OF THE INVENTION

Liquid detergents comprising microcapsules are very appealing to consumers. The inclusion of microcapsules in liquid detergents is desirable not only for aesthetic reasons but also for functional reasons such as isolation of incompatible ingredients, controlled and/or delayed release, etc. Ideally, the microcapsules are stably suspended in the liquid detergent and only dissolve/disintegrate upon use. Since consumers generally desire a clean and fresh odor whenever they open the package and smell the product, as well as during the laundering process, such as a clean and fresh odor in the laundry room, and on laundered clothing, perfume microcapsules have been used in consumer products to improve fragrance deposition, retention and longevity.

One problem encountered with the production of liquid detergents comprising encapsulated actives is that the distribution of the capsules encapsulating these actives within the liquid matrix needs to be controlled so that the capsules do not overly float, sink or otherwise gravitate during processing, when packaged for later processing with other ingredients, or when in a packaged consumer product. In order to properly disperse and suspend the capsules within the liquid matrix, thickening agents can be introduced into the composition. There are number of compounds, which can provide structuring and thickening benefits.

Known external thickening agents include polymers or gums such as gellan gum, alginate, carrageenan, xanthan gum, and guar gum. Although gums have been used to provide structuring benefits, the gums have been found to be undesirable due to pH and electrolyte sensitivity, which can decrease their structuring capacity or lead to other undesirable issues such as gelling or clumping of the product.

The addition of pearlescent agents such as inorganic natural substances, such as mica, bismuth oxychloride and titanium dioxide, and organic compounds such as fish scales, metal salts of higher fatty acids, fatty glycol esters and fatty acid alkanolamides results in a highly desirable opaqueness and pearlescence. These aesthetic features of a liquid detergent composition may help draw and divert the consumer's attention and, as possible instability of capsules contained in the liquid detergent composition is dissimulated, give the impression of a homogenous, stable, appealing product.

It is therefore an object of the present invention to provide a pearly liquid detergent composition which is characterized by an aesthetically highly desirable opaqueness and pearlescence, which dissimulates the capsules encapsulating actives contained in said liquid detergent compositions, and which further comprises thickening agents that help suspending part of said capsules and prevent them from sedimenting or floating on the surface of the liquid detergent composition.

Accordingly, it is desirable to provide a pearly liquid detergent composition that is aesthetically appealing to consumers, functional, and stable. It is also desirable to provide a method for cleaning textiles by contacting such pearly liquid detergent composition with textiles followed by conventional manual or machine cleaning methods. Other desirable features and characteristics of the present invention will become apparent from the subsequent detailed description of the invention and the appended claims, taken in conjunction with this background of the invention.

### BRIEF SUMMARY OF THE INVENTION

In a first aspect, the present invention thus relates to a liquid detergent composition comprising:
a) at least one pearlescent formulation in an amount of 0.05% to 2% by weight of said liquid detergent composition,
b) at least one thickening agent in an amount of 0.05% to 2% by weight of said liquid detergent composition,
c) capsules encapsulating actives in an amount of 0.005% to 0.5% by weight of said liquid detergent composition.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In another aspect, the present invention relates to a method for cleaning textiles, wherein a washing liquor containing the liquid detergent composition of the invention contacts the textile in at least one method step.

In the context of the present invention, pearlescent formulations comprise at least one pearlescent agent. Pearlescent agents are crystalline or glassy solids, transparent or translucent compounds capable of reflecting and refracting light to produce a pearlescent effect. Typically, the pearlescent agents are crystalline particles insoluble in the composition in which they are incorporated. Preferably, the pearlescent agents have the shape of thin plates or spheres. Spheres, according to the present invention, are to be interpreted as generally spherical. Particle size is measured across the largest diameter of the sphere. Plate-like particles are such that two dimensions of the particle (length and width) are at least 5 times the third dimension (depth or thickness). Other crystal shapes like cubes or needles or other crystal shapes do typically not display pearlescent effects. Many pearlescent agents like mica are natural minerals having monoclinic crystals. Shape appears to affect the stability of the agents. The spherical, even more preferably, the plate-like agents being the most successfully stabilized.

Pearlescent agents are known in the art, but mostly for use in shampoo, conditioner or other personal care applications. Light reflected from such pearlescent platelets or spheres, as they lie essentially parallel to each other at different levels in the composition, creates a sense of depth and luster. Some light is reflected off the pearlescent agent, and the remainder will pass through the agent. Light passing through the pearlescent agent, may pass directly through or be refracted. Reflected, refracted light produces a different color, brightness and luster.

The liquid detergent composition of the present invention preferably comprises from 0.05 to 2% by weight of the composition of at least one pearlescent agent. More preferably, the at least one pearlescent agent is present in an amount of 0.1% to 1% by weight of said liquid detergent composition, most preferably 0.3% to 0.4% by weight of said liquid detergent composition.

In detergent compositions according to the present invention, pearlescent visual effects may be achieved by addition of certain pearlescent formulations. In the context of the present invention, these pearlescent formulations preferably comprise at least one alkylene glycol ester.

Alkylene glycol esters, especially monoesters of alkylene glycol, may generally be selected from at least one compound having the formula:

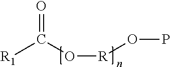

wherein R₁ is linear or branched C12-C22 alkyl group;
is linear or branched C2-C4 alkylene group;
P is selected from H, C1-C4 alkyl or —COR₂, R₂ is C4-C22 carbohydrate group; and
n=1-3.

In a preferred embodiment of the present invention, the long chain fatty ester has the general structure described above, wherein R₁ is linear or branched C16-C22 alkyl group, R is —CH₂—CH₂—, n is 1; and P is selected from, preferably, H, or —COR₂, wherein R₂ is C4-C22 alkyl.

Typical examples are monoesters and/or diesters of ethylene glycal, propylene glycol, diethylene glycol, dipropylene glycol, triethylene glycol or tetraethylene glycol with fatty acids containing from about 6 to about 22, preferably from about 12 to about 18 carbon atoms; such as caproic acid, caprylic acid, 2-ethyhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, arachic acid, gadoleic acid, behenic acid, erucic acid, and mixtures thereof.

In a preferred embodiment, the composition comprises alkylene glycol esters in combination with at least one surfactant and at least one betaine.

Surfactants, which may be comprised in such pearlescent formulations, may be selected from the group consisting of C10-16 fatty alcohol ether sulfates, comprising, for example, 1 to 7 alkoxy units (AO), in particular ethoxy units (EO). Particularly preferred are C10-16, preferably C12, fatty acid ether sulfates with 2 to 7 EO, preferably 3 EO. These C10-16 fatty alcohol ether sulfates may be present in form of their sodium salts. However, other alkali or earth alkali salts may also be suitable.

Betaines, which may be comprised in the aforementioned pearlescent formulations, may be selected from the group consisting of alkylamidopropyl betaines, preferably linear C8-C16 alkylamidopropyl betaines, and particularly cocoamidopropyl betaine, in which {3-(Dodecanoylamino)propyl](dimethyl)ammonio}acetat is comprised as a main ingredient. Betaines of this type are commercially available under the brand name Tego® Betaine by Evonik Industries.

In a preferred embodiment of the present invention, the pearlescent formulation comprises glycol cetearate, sodium laureth sulfate and cocamidopropyl betaine. Such a composition is, for example, commercially available from Huntsman under the tradename Empipearl® XA 200/X.

Optionally, co-crystallizing agents may be used to enhance the crystallization of the organic pearlescent agents such that pearlescent particles are produced in the resulting product. Suitable co-crystallizing agents include but are not limited to fatty acids and/or fatty alcohols having a linear or branched, optionally hydroxyl substituted, alkyl group containing from about 12 to about 22, preferably from about 16 to about 22, and more preferably from about 18 to 20 carbon atoms, such as palmitic acid, linoleic acid, stearic acid, oleic acid, ricinoleic acid, behenyl acid, cetearyl alcohol, hydroxystearyl alcohol, behenyl alcohol, linolyl alcohol, linolenyl alcohol, and mixtures thereof.

When the co-crystallizing agents are selected to have a higher melting point than the organic pearlescent agents, it is found that in a molten mixture of these co-crystallizing agents and the above organic pearlescent agents, the co-crystallizing agents typically solidify first to form evenly distributed particulates, which serve as nuclei for the subsequent crystallization of the pearlescent agents. With a proper selection of the ratio between the organic pearlescent agent and the co-crystallizing agent, the resulting crystals sizes can be controlled to enhance the pearlescent appearance of the resulting product. It is found that if too much co-crystallizing agent is used, the resulting product exhibits less of the attractive pearlescent appearance and more of an opaque appearance.

For example, the weight ratio between the organic pearlescent agent and the co-crystallizing agent may range from about 3:11 to about 10:1, or from about 5:11 to about 20:1.

In addition to or instead of the afore-mentioned, inorganic pearlescent agents may also be used in liquid detergent compositions according to the present invention. An inorganic pearlescent agent is considered to be inorganic, when it does not comprise a covalent bond between a carbon atom and a hydrogen atom and when it additionally doe not comprise a covalent bond between two carbon atoms. Inorganic pearlescent agents include those selected from the group consisting of mica, metal oxide coated mica, silica coated mica, bismuth oxychloride coated mica, bismuth oxychloride, glass, metal oxide coated glass, metallic glitter, and mixtures thereof.

Suitable micas include muscovite or potassium aluminum hydroxide fluoride. The platelets of mica are preferably coated with a thin layer of metal oxide. Preferred metal oxides are selected from the group consisting of rutile, titanium dioxide, ferric oxide, tin oxide, alumina and mixtures thereof. The crystalline pearlescent layer is formed by calcining mica coated with a metal oxide at about 732° C. The heat creates an inert pigment that is insoluble in resins, has a stable color, and withstands the thermal stress of subsequent processing

Color in these pearlescent agents develops through interference between light rays reflecting at specular angles from the top and bottom surfaces of the metal-oxide layer. The agents lose color intensity as viewing angle shifts to non-specular angles and gives it the pearlescent appearance.

More preferably, inorganic pearlescent agents are selected from the group consisting of mica and bismuth oxychloride and mixtures thereof. Most preferably, inorganic pearlescent agents are mica. Commercially available suitable inorganic pearlescent agents are available from Merck under the tradenames Iriodin, Biron, Xirona, Timiron Colorona, Dichrona, Candurin and Ronastar. Other commercially available inorganic pearlescent agent are available from BASF (Engelhard, Mearl) under tradenames Biju, Bi-Lite, Chroma-Lite, Pearl-Glo, Mearlite and Eckart under the tradenames Prestige Soft Silver and Prestige Silk Silver Star.

Inorganic pearlescent agents are available as a powder or as a slurry of the powder in an appropriate suspending agent. Suitable suspending agents include ethylhexyl hydroxystearate, hydrogenated castor oil. The powder or slurry of the powder can be added to the composition without the need for any additional process steps.

In various embodiments of the present invention, organic pearlescent agents, such as those described above are preferred.

It is essential for the present invention that the liquid composition comprises a thickening agent, preferably a cross-linked acrylic copolymer. In the liquid detergent composition according to the present invention, the thickening agent is present in an amount of 0.05% to 2% by weight of said liquid detergent composition, preferably in a range of 0.1% to 1% by weight of said liquid detergent composition, more preferably in a range of 0.4% to 0.6% by weight of said liquid detergent composition.

The composition comprises at least one thickening agent in an amount of 0.05% to 2% by weight of said liquid detergent composition, preferably in a total amount of 0.1% to 1.0% by weight of said liquid detergent composition.

It is highly preferred, that as a thickening agent the composition comprises at least one polymeric thickener. A polymeric thickener is a polymer with an average molecular weight (M_{w}) of at least 1000 g/mol.

Preferred polymeric thickener are according to the invention polyacrylate polymers, polysaccharides as starch, hydroxyalkylated starch, cellulose, hydroyalkylated cellulose. The polyacrylate polymers are especially preferred polymers or copolymers of polyacrylate, polymers or copolymers of polymethacrylate. Said polyacrylate polymeric thickener is preferably selevted from polyalkenylpolyether, especially allylether of saccharose, pentaerythrit or propylen, crosslinked homopolymers of acrylic acid (INCI-declaration according to “International Dictionary of Cosmetic Ingredients of The Cosmetic, Toiletry and Fragrance Association (CTFA): Carbomer))”, which are also known as carboxyvinylpolymers. Such polyacrylic acids are available from company 3V Sigma as Polygel®, e.g. Polygel DA, and of company Noveon as Carbopol®, eg. Carbopol 940 (M_{w} ca. 4.000.000), Carbopol 941 (M_{w} ca. 1.250.000) or Carbopol 934 (M_{w} ca. 3.000.000). Preferred acrylic acid-copolymers are: (i) Copolymers of two or more monomers selected from acrylic acid, methacrylic acid and their esters with C₁₋₄-alkanols (INCI Acrylates Copolymer), especially copolymers of methacrylic acid, butylacrylate and methyl methacrylate (CAS-number according to Chemical Abstracts Service: 25035-69-2) or copolymers of butylacrylate and methyl methacrylats (CAS 25852-37-3) which can be purchased from company Rohm & Haas as Aculyn® and Acusol® or from company Evonik (Goldschmidt) as Tego® Polymer, eg. The anionic and non-associative polymers Aculyn 22, Aculyn 28, Aculyn 33 (crosslinked), Acusol 810, Acusol 823 and Acusol 830 (CAS 25852-37-3); (ii) crosslinked acrylic acid-copolymers, especially copolymers of C₁₀₋₃₀-alkyl acrylates with one or more monomers, selected from acrylic acid, methacrylic acid, and their ester with C₁₋₄-alkanols, which are crosslinked with an allylether of saccharose or pentaerythrit (INCI Acrylates/C10-30 Alkyl Acrylate Crosspolymer), which are for example sold by company Noveon as Carbopol®, eg. hydrophobic Carbopol ETD 2623 and Carbopol 1382 (INCI Acrylates/C10-30 Alkyl Acrylate Crosspolymer) as well as Carbopol Aqua 30 (the renamed Carbopol EX 473).

Preferred polymeric thickener from polysaccharides are selected from starch, dextrin, carboxymethylstarch, cellulose, carboxymethylcellulose, hydroxyethylcellulose, xanthan gum, carrageenan, guar gum, gum Arabic and mixtures thereof.

It is particularly preferred, that the composition comprises as a thickening agent at least one polymeric thickener selected from polyacrylate polymers and one polymeric thickener, selected from polysaccharides.

The liquid detergent composition comprises capsules, preferably microcapsules, which encapsulate one or more actives. In the liquid detergent composition according to the present invention, said capsules are present in a concentration range of 0.005% to 0.5% by weight of said liquid detergent composition, preferably in a range of 0.01% to 0.3% by weight of said liquid detergent composition, more preferably in a range of 0.1% to 0.25% by weight of said liquid detergent composition.

It is preferred that the encapsulated actives comprise an active selected from the group consisting of perfumes, softening agents, anti-static agents, refreshing agents, anti-microbial agents, disinfecting agents, anti-wrinkle agents, malodor control agents, insect/pet repellents, skin/fabric conditioning agents, silicones, anti-microbials, brighteners, bleaches, antifoams, and combinations thereof. In a preferred embodiment of the present invention, the encapsulated active comprises a perfume.

The preferred capsules have a d₉₀ value of below 50 μm, more preferred a d₉₀ value of below 40 μm and most preferred a d₉₀ value of below 30 μm.

The d₉₀ defines that equivalent diameter where 90 mass-% of the capsules encapsulating actives have a smaller diameter.

In a very preferred embodiment of the invention, the capsules encapsulating actives have a diameter between 1 and 15 μm.

In various embodiments, the capsules comprise friable microcapsules, moisture-activated microcapsules, heat-activated microcapsules, or combinations thereof.

The capsules preferably comprise friable microcapsules. “Friability” refers to the propensity of the microcapsules to rupture or break open when subjected to direct external pressures or shear forces. For purposes of the present invention, the microcapsules utilized are “friable” if, while attached to fabrics treated therewith, they can be ruptured by the forces encountered when the capsule-containing fabrics are manipulated by being worn or handled (thereby releasing the contents of the capsule).

Although a preferred embodiment of the present invention is directed to actives encapsulated within friable microcapsules, the present invention is not being limited to only those microcapsules.

Typically, microcapsules comprise a spherical hollow shell of water insoluble or at least partially water insoluble material, typically polymer material, within which the active is contained.

Useful shell materials include materials selected from the group consisting of polyethylenes, polyamides, polystyrenes, polyisoprenes, polycarbonates, polyesters, polyacrylates, polyureas, polyurethanes, polyolefins, polysaccharides, epoxy resins, vinyl polymers, and mixtures thereof. Suitable shell materials include materials selected from the group consisting of reaction products of one or more amines with one or more aldehydes, such as urea cross-linked with formaldehyde or gluteraldehyde, melamine cross-linked with formaldehyde; gelatin-polyphosphate coacervates optionally cross-linked with gluteraldehyde; gelatin-gum Arabic coacervates; cross-linked silicone fluids; polyamine reacted with polyisocyanates and mixtures thereof. In a preferred embodiment, the shell material comprises melamine cross-linked with formaldehyde.

Microcapsules may be prepared using a range of conventional methods known to those skilled in the art for making shell capsules, such as interfacial polymerization, and polycondensation. With the help of these methods a thin polymer shell is created around droplets or particles of an active emulsified or dispersed in a carrier liquid.

Usually, the encapsulated actives are introduced into the liquid detergent composition in the form of an aqueous slurry of the microcapsules.

In a preferred embodiment, the active comprises a perfume. Non-limiting examples of suitable perfumes include blooming perfumes, perfume oils, and perfume raw materials comprising alcohols, ketones, aldehydes, esters, ethers, nitriles alkenes, and mixtures thereof.

In addition to the encapsulated perfume active, the liquid detergent composition according to the present invention may further comprise a free, non-encapsulated perfume.

A general range of encapsulated active concentration, for example perfume microcapsules content, of the microcapsules slurry is between 1 and 50%, by weight, relative to the weight of the slurry, the latter also containing typically 4 to 20% by weight of encapsulating shell material in a free form, and the balance being water.

Preferably, the liquid detergent composition is a liquid laundry detergent composition or a liquid cleaning detergent composition and most preferred the liquid detergent composition is an aqueous liquid laundry detergent composition.

In addition to the at least one pearlescence formulation, the thickening agent and the microcapsules, the liquid detergent composition according to the present invention may contain one or more further ingredients typically used in liquid detergent composition. Accordingly, in various embodiments, the liquid detergent composition additionally contains one or more substances selected from the group consisting of, without limitation, other surfactants, detergency builders, bleaching agents, bleach activators, bleach catalysts, enzymes, non-aqueous solvents, pH adjusting agents, free perfumes, fluorescing agents, dyes, hydrotopes, silicone oils, anti-redeposition agents, anti-graying agents, shrinkage preventers, wrinkle protection agents, dye transfer inhibitors, antimicrobial active substances, germicides, fungicides, antioxidants, preservatives, corrosion inhibitors, antistatic agents, bittering agents, ironing adjuvants, proofing and impregnation agents, swelling and anti-slip agents, softening compounds, complexing agents and UV absorbers.

In preferred embodiments, the composition is a liquid laundry detergent composition and comprises one or more of detergency builders, enzymes, non-aqueous solvents, pH adjusting agents, free perfumes, fluorescing agents, dyes, silicone oils, soil-release polymers, anti-gray agents, dye transfer inhibitors, and preservatives.

Liquid or pasty detergents according to the invention in the form of solutions containing conventional solvents are generally produced by simply mixing the constituents, which may be introduced into an automatic mixer as an undissolved material or as a solution.

The invention further encompasses methods for cleaning textiles, wherein a washing liquor containing the detergent composition according to the invention contacts the textile in at least one method step. These include both manual and machine methods, wherein machine methods are preferred, due to their being more precisely controllable, for example in terms of the quantities used and periods of exposure. Methods for cleaning textiles are in general distinguished in that in two or more method steps various substances with a cleaning action are applied onto the material to be cleaned and, after the period of exposure, are washed off, or that the material to be cleaned is treated in some other manner with a washing agent or a solution or dilution of this agent. Any conceivable washing methods may be enhanced in at least one of the method steps by application of a detergent composition according to the invention and then constitute embodiments of the present invention.

In various embodiments, the method is characterized in that it is carried out at a temperature of between 10° C. and 60° C., preferably between 20° C. and 50° C. and more preferably of between 30° C. and 50° C.

All factors, aspects and embodiments which have been described for detergent compositions according to the invention are also applicable to this aspect of the invention. Express reference is therefore made at this point to the disclosure at corresponding points, it being pointed out that this disclosure also applies to the above methods according to the invention.

### EXAMPLES

TABLE 1
Inventive liquid laundry detergent compositions

| | E1: Amount | E2: Amount |
|---|---|---|
| Component | active (wt.-%) | active (wt.-%) |
| Water | Rest | Rest |
| Mixture of glycol cetearate, | — | 0.30 |
| sodium laureth | | |
| sulfate and cocamidopropyl betaine | | |
| Titaniumdioxide coated mica | 0.2 | — |
| (inorganic pearlescent agent) | | |
| Boric acid | 0.6 | 0.6 |
| Citric acid anhydrate | 0.3 | 0.3 |
| 4,4′-Bis(2-sulfostyrene)biphenyl, | 0.035 | 0.035 |
| sodium salt | | |
| C₁₂-C₁₈-fatty alcohol | 4.3 | 4.3 |
| erthoxylated with 7 EO | | |
| (Dehydol LT 7) | | |
| Laurylethersulfate, sodium | 3.9 | 3.9 |
| salt, ethoxylated | | |
| with 2 EO (Texapon ® N 70) | | |
| linear C₁₀-C₁₃-alkylbenzenesulfonic | 3.5 | 3.5 |
| acid | | |
| Diethylenetriaminepenta | 0.257 | 0.257 |
| (methylenephosphonic | | |
| acid), hepta-sodium salt | | |
| Glycerol | 0.643 | 0.643 |
| C₁₂₋₁₈ fatty acid | 0.643 | 0.643 |
| NaOH | 0.771 | 0.771 |
| Crosslinked polyacrylates | 0.5 | 0.5 |
| Hydroxyethylcellulose | 0.1 | 0.1 |
| Acticide MBS 2550 | 0.1 | 0.1 |
| NaCl | 0.8 | 0.8 |
| Perfume | 0.741 | 0.741 |
| Dye | 0.006 | 0.006 |
| Mannanase | 0.04 | 0.04 |
| Cellulase | 0.1 | 0.1 |
| Amylase | 0.15 | 0.15 |
| Protease | 0.336 | 0.336 |
| Perfume capsules | 0.2 | 0.2 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A liquid detergent composition comprising:
a) at least one pearlescent formulation in an amount of 0.05% to 2% by weight of said liquid detergent composition,
b) at least one thickening agent in an amount of 0.05% to 2% by weight of said liquid detergent composition,
c) active encapsulated capsules in an amount of 0.005% to 0.5% by weight of said liquid detergent composition.

2. The liquid detergent composition of claim 1, wherein the at least one pearlescent formulation is present in an amount of 0.1% to 1% by weight of said liquid detergent composition.

3. The liquid detergent composition of claim 1, wherein the at least one thickening agent is present in an amount of 0.1% to 1% by weight of said liquid detergent composition.

4. The liquid detergent composition of claim 1, wherein the active encapsulated capsules are present in an amount of 0.01% to 0.3% by weight of said liquid detergent composition.

5. The liquid detergent composition of claim 1, wherein the at least one pearlescent formulation comprises at least one monoester of an alkylene glycol selected from at least one compound having the formula: 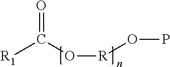
wherein R₁ is linear or branched C12-C22 alkyl group;
wherein R is linear or branched C2-C4 alkylene group;
wherein P is selected from H, C1-C4 alkyl or —COR₂;
wherein R₂ is C4-C22 carbohydrate group; and
wherein n=1-3.

6. The liquid detergent composition of claim 1, wherein the at least one pearlescent formulation comprises at least one inorganic pearlescent agent.

7. The liquid detergent composition of claim 6, wherein the at least one inorganic pearlescent agent is selected from the group consisting of mica, metal oxide coated mica, silica coated mica, bismuth oxychloride coated mica, bismuth oxychloride, glass, metal oxide coated glass, metallic glitter, and mixtures thereof.

8. The liquid detergent composition of claim 1, wherein the at least one pearlescent formulation comprises at least one monoester of an alkylene glycol, at least one sodium salt of a fatty alcohol ether sulfate, and at least one betaine.

9. The liquid detergent composition of claim 1, wherein the capsules comprise microcapsules.

10. The liquid detergent composition of claim 1, wherein the capsules comprise a perfume as an encapsulated active.

11. The liquid detergent composition of claim 1, wherein the liquid detergent composition comprises at least one surfactant.

12. The liquid detergent composition of claim 1, wherein the liquid detergent composition comprises at least one polymeric thickener selected from polyacrylate polymers, and at least another polymeric thickener selected from polysaccharides.

13. The liquid detergent composition of claim 1, wherein the liquid detergent composition comprises the thickening agent in a total amount of 0.1 to 1.0% by weight of said liquid detergent composition.

14. The liquid detergent composition of claim 1, wherein the liquid detergent composition further comprises at least one substance selected from the group consisting of detergency builders, bleaching agents, bleach activators, bleach catalysts, enzymes, non-aqueous solvents, pH adjusting agents, free perfumes, fluorescing agents, dyes, hydrotopes, silicone oils, anti-redeposition agents, anti-gray agents, shrinkage preventers, wrinkle protection agents, dye transfer inhibitors, antimicrobial active substances, germicides, fungicides, antioxidants, preservatives, corrosion inhibitors, antistatic agents, bittering agents, ironing adjuvants, proofing and impregnation agents, swelling and anti-slip agents, softening compounds, complexing agents, and UV absorbers.

15. A method for cleaning textiles, comprising a step of contacting a washing liquor containing the liquid detergent composition of claim 1 with the textiles.
